(19) United States
(12) Patent Application Publication
(10) Pub. No.: US 2008/0118719 A1
(43) Pub. Date: May 22, 2008

(54) Powder coating of gas turbine engine components

(76) Inventors: Andrew Jay Skoog, West Chester, OH (US); Matthew Buczek, Hamilton, OH (US); Mark Rechtsteiner, Cincinnati, OH (US)

Correspondence Address: HARRINGTON & SMITH, PC, 4 RESEARCH DRIVE, SHELTON, CT, 06484-6212, US

(21) Appl. No.: 11/698,546

(22) Filed: Jan. 25, 2007

Related U.S. Application Data
(62) Division of application No. 10/798,134, filed on Mar. 10, 2004.

(51) Int. Cl. B32B 5/00

(52) U.S. Cl. 428/206

(57) ABSTRACT

In accordance with one embodiment of the invention, there is provided a method of coating a gas turbine engine component using a powder coating process. The method comprises providing a gas turbine engine component; and applying a powder coating to the gas turbine engine component using the powder coating process. The powder coating is applied in a dry form without an organic solvent. The method further comprises heating the applied powder coating to melt and fuse particles of the powder coating to the gas turbine engine component and cure the powder coating.

### FIELD OF THE INVENTION

The invention relates to powder coating processes and, more particularly, to powder coating of gas turbine engine components.

### BACKGROUND OF THE INVENTION

In general, two primary technologies have evolved in the coating industry: liquid coating technology, which may also be referred to as wet coating technology and powder coating technology, which may be referred to as dry coating technology.

Examples of the liquid coating technology include organic solvent type coatings and aqueous emulsion type coatings. Organic solvent type coatings, which are obtained by dissolving main components, such as resins, in an organic solvent and adding thereto auxiliary components, such as coloring agents, have been used widely in various coating applications. However, problems have been encountered with the use of these coatings, including fire hazards, adverse effects on safety/hygiene and environmental pollution. Accordingly, increased attention is being directed to coatings that vaporize no organic solvent, particularly aqueous emulsion type coatings and powder coatings.

Aqueous emulsion type coatings, however, also have certain shortcomings. For example, resin particles and a pigment are typically dispersed stably in an aqueous medium and thus a hydrophilic substance, such as an emulsifier, is employed during the production process. Additionally, the resultant film is often inferior in properties, such as alkali resistance and water resistance. Moreover, the film frequently has low adhesivity to the material being coated. It also takes a significant amount of time to obtain a dried film, as compared to that of an organic solvent type coating, and if it is necessary to complete the film drying in a short amount of time then special equipment is required at higher costs.

In contrast, powder coatings, which contain no organic solvent, have various advantages. For example, powder coatings typically have very low volatile organic content and release very little volatile material to the environment when cured. Powder coatings are also free from flammable solvents, adverse effects on safety/hygiene and environmental pollution. Further advantages include the ability to be stored in an ordinary storehouse; the amount of ventilation air in a spray booth can be minimized and the air can be recirculated, resulting in high energy efficiency; and the coating film obtained has no foams generated by the vaporization of solvent during film drying. Other advantages of powder coatings include use without the necessity of adjusting viscosity, solid content, etc.; the coatings can be easily recovered without staining the operation site and producing any waste; and powder that does not adhere to a surface can be recycled. Furthermore, powder coatings can be applied by automated coating procedures and, in view of the total cost including cost of materials, pretreatment cost, cost of coating operation, equipment cost, etc., these coatings are very economical as compared to organic solvent type coatings and aqueous type coatings.

Powder coatings generally comprise a solid-film forming resin, often with one or more pigments. Thermosetting powder coating compositions and their method of preparation are described in U.S. Pat. No. 6,649,267 to Agawa et al. Similarly, U.S. Pat. No. 6,531,524 to Ring, et al. describes powder coating compositions. Although powder coatings may be thermoplastic-based, they are typically based on thermosetting materials. Themoplastic based coatings melt and flow onto the substrate during increases in temperature, but do not undergo a chemical reaction. Themoplastic based coatings are typically applied to a greater thickness than that of thermosetting coatings.

In contrast, thermosetting powder coatings melt upon increase in temperature and undergo a chemical reaction to polymerize through cross-linking mechanisms into a resistant resultant film. These thermosetting coatings do not remelt once the chemical reaction has occurred.

In general, powder coating technology is an advanced method of applying decorative and protective finishes to products to enhance features, such as color and scratch resistance. Typically, the powder coating is applied by a spray technique wherein the powder constituents are sprayed onto an article and then heated to fuse the powder onto the article. The powder particles are attracted to the article by an electrical charge. Industries that have benefited from powder coating technology include the appliance and architecture industries.

However, to the inventors knowledge, powder coating technology has not been employed to coat gas turbine engine components in the aerospace industry. In particular, gas turbine engines operate at increasingly high temperatures due to the increased desire for further efficiency. Accordingly, the gas turbine engine components must be able to withstand the increased temperatures and thus coatings are often employed over the components to provide further protection. In particular, numerous coatings are used in gas turbine engine systems for purposes of: heat/thermal control, sand/rain erosion resistance, wear resistance, corrosion resistance/sacrificial coatings, and many others. A number of these coatings use solvents, which may be harmful or toxic. Some coatings also include constituents that allow them to work for special applications, but are toxic (e.g. chromium) or release organic effluents during processing. Additionally, the coatings must often operate at temperatures anywhere from subambient to extremely hot (e.g. in excess of 2000° F./1093° C.).

Thermal spray processes, including detonation gun deposition, plasma spray, electric wire arc spray, flame spray and high velocity oxy-fuel, have been extensively used in the gas turbine engine industry to deposit coatings on various engine components. In most of these thermal spray processes, materials such as ceramic, polymeric or metallic materials in wire, powder or other forms are heated to at or above its melting point. Droplets of the melted material are directed against the surface of a substrate to be coated via a gas stream and adhere and flow onto the component where a buildup of coating results. However, these processes are often complicated and require extensive equipment and set up procedures. Moreover, thermal spray processes may also be characterized similar to the liquid coating technology, shortcomings of which have been described above in detail.

Accordingly, there exists a need for a new method of coating gas turbine engine components. The present invention addresses this need and others.

### BRIEF DESCRIPTION OF THE INVENTION

In accordance with one embodiment of the invention, there is provided a method of coating a gas turbine engine component using a powder coating process. The method comprises providing a gas turbine engine component; and applying a powder coating to the gas turbine engine component using the powder coating process. The powder coating is applied in a dry form without an organic solvent. The method further comprises heating the applied powder coating to melt and fuse particles of the powder coating to the gas turbine engine component and cure the powder coating. In accordance with another embodiment of the invention, there is provided a method of coating a gas turbine engine component using a powder coating process. The method comprises providing a gas turbine engine component having an electrically conductive substrate; cleaning the gas turbine engine component prior to application of a powder coating; and applying a powder coating to the gas turbine engine component using the powder coating process. The powder coating is applied in a dry form without an organic solvent. The powder coating process comprises spraying and charging electrostatically the powder composition through a spray gun onto the gas turbine engine component, which is grounded; and heating the applied powder coating to melt and fuse particles of the powder coating to the gas turbine engine component and cure the powder coating.

In accordance with a further embodiment of the invention, a gas turbine engine component having a cured powder coating thereon is disclosed. The powder coating is advantageously applied is dry form without use of an organic solvent.

Other features and advantages will be apparent from the following more detailed description read in conjunction with the attached Figures.

### BRIEF DESCRIPTION OF THE DRAWINGS

FIG. 1 is a schematic illustration of a method of powder coating a gas turbine engine component using a tribo electrostatic spray process, in accordance with an embodiment of the invention; and

FIG. 2 is a schematic illustration of a method of powder coating a gas turbine engine component using a corona electrostatic spray process, in accordance with an embodiment of the invention.

### DETAILED DESCRIPTION OF THE INVENTION

In accordance with one embodiment of the invention, a method of powder coating a gas turbine engine component is disclosed.

The gas turbine engine component may be any type of gas turbine engine component, including but not limited to frames, controls and accessory equipment (e.g. gear boxes, oil tanks), blades, shafts, disks, vanes, combustor liners, exhaust flaps, exhaust seals, etc. Similarly, the component may be made out of any suitable material and is typically a metallic material, such as a nickel-based, cobalt-based or iron-based superalloy. However, the gas turbine engine component substrate may be any substrate capable of carrying an electrostatic charge. A non-metallic substrate, such as composites or ceramic materials, may also be employed provided the substrate may be modified to be electrically conductive. The substrate of the gas turbine engine component may be coated directly by the powder coating processes described herein or may have a powder coating applied over a preexisting coating(s) on the gas turbine engine component.

The substrate may be chemically or mechanically cleaned prior to application of a powder coating composition and is preferably subject to chemical pretreatment, for example, with iron phosphate, zinc phosphate or chromate. The substrate may also be preheated prior to application or pretreated with a material that will aid the powder coating application. This optional preheat also promotes uniform and thicker powder deposition.

The powder coatings applied to the gas turbine engine component may be any coating suitable to be applied by powder coating processes. Organic based, as well as inorganic based materials may be employed. Organic based materials are particularly suited for lower operating temperature components, such as inlet fans, frames, ducts, guide vanes, accessory equipment (e.g. oil tanks, gear boxes) and some exhaust components, having operating temperatures up to about 600° F. (316° C.). In general, organic polymers may be characterized by good flexibility and resistance to chemical attack by inorganic materials. Suitable organic based materials, which may be employed in embodiments of the invention, include fluoroelastomers, epoxies, and urethanes. Powder coatings also may be made of frit, which is a ground glass used in making glazes and enamels. Finely powdered glass may also be referred to as frit. The term, frit, may also refer to finely ground inorganic minerals, mixed with fluxes and coloring agents that form glass or enamel upon heating.

A powder coating composition may be conventionally prepared by mixing raw materials, such as resins, curing agents, plasticizers, stabilizers, fluidity modifiers, pigments and fillers in a mixer. This may be followed by melt-kneading the mixture in a high shear mixer, such as an extruder, to disperse the respective raw materials. The melt-kneaded mixture may then be cooled, ground into powders and classified. The use of particles of a particular size may impart specific desired properties to the cured powder-coated substrate, such as smoothness, fluidity and electrostatic coatability, as known in the powder coating industry.

Additives may also be added to the powder coating compositions depending upon the desired application. Examples of conventionally known additives include pigment dispersants, curing catalysts, flow modifiers, matting agents, blocking inhibitors, ultraviolet absorbers, photostabilizers, benzoin, antistatic agents, antioxidants and synthetic resins, such as epoxy resin, polyester resin, urethane resin, and polyamide resin.

In general, inorganic materials provide coating and bonding compositions having excellent heat and abrasion resistance and resistance to chemical attack or corrosion by organics and some inorganics. Inorganic materials are particularly suited for coating higher temperature operating components, including turbine blades and hot exhaust components, having operating temperatures up to about 2400° F. Suitable inorganic based materials, which may be employed in embodiments of the invention include glass/enamels, glass, ceramics, glass/ceramic and matrix materials of the same with admixed with metals.

Sacrificial electrically conductive coatings that prevent corrosion by corroding in place of the substrate are particularly useful to be deposited on gas turbine engine components, by embodiments described herein. In particular, when a more active metal is placed in contact with one that reacts more slowly, such as a more noble metal, the active metal will typically be consumed by the environmental factors before the other material begins to corrode. Thus, the more active metal may be said to “sacrifice” itself to protect the less active metal. A number of coating systems have been built around this sacrificial principle and may be employed herein. For ex ample, aluminum-filled inorganic phosphate overlay coatings are useful to combat corrosion and erosion of steel components. U.S. Pat. No. 3,248,251 to Allen describe water-based slurries containing aluminum powder or alloy pigment particles dispersed in an acidic solution containing phosphates and hexavalent chromium ions which, upon exposure to heat and curing, transform to an insoluble metal/ceramic composite. Chromates or dichromates, molybdates, vanadates, tungstates and other ions may also be present. A commercial example of such a material is SermeTel W® manufactured by Sermatech International Inc. Coating compositions containing hexavalent chromium and phosphate are also described in other patents, such as U.S. Pat. Nos. 4,381,323 and 4,319,924.

Other inorganic coatings include various fritted glass materials for lower temperature use below about 1800° F. (982° C.). Similarly, other glass frits that are referred to as recrystallizable could be used for lower initial melting temperatures with higher final use temperatures. Additionally, glass/ceramic systems may use glass material as mentioned earlier as a matrix with ceramic particles trapped in this matrix. These ceramics can react with the glass matrix thereby raising the glass melting point and resulting in higher use temperatures. Suitable ceramics include alumina, zirconia, yttria stabilized zirconia, MgO, TiO₂, etc.

Preferably, the powder coating comprises nonconductive materials. However, conductive materials, such as metallic powder encapsulated in or coated with a nonconductive material, such as a ceramic, may also be employed.

The powder coatings may be applied to the gas turbine engine component by any suitable powder coating process. In general, the powder coating may typically be applied by electrostatic spray processes or fluidized bed processes. For example, the powder coatings may be applied by spraying and charging electrostatically the powder through a spray gun onto the gas turbine engine component. Powder coating processes, such as fluidized bed dipping, electrostatic brush processes and powder cloud applications may also be employed.

According to one embodiment of the invention, a method for forming a powder coating on a gas turbine engine component comprises applying a powder coating to a substrate by an electrostatic spray coating process and heating the applied coating to melt and fuse the particles and cure the coating. The electrostatic spray coating process may be a corona charging or tribo charging process. In the case of a tribo charging process, it is recommended that the powder coating composition should be one that has been formulated especially for such application, for example, by the use of suitable polymers of which the so-called “tribo-safe” grades are an example or by the use of additives, which can be introduced prior to extrusion in a manner known to those skilled in powder coating processing.

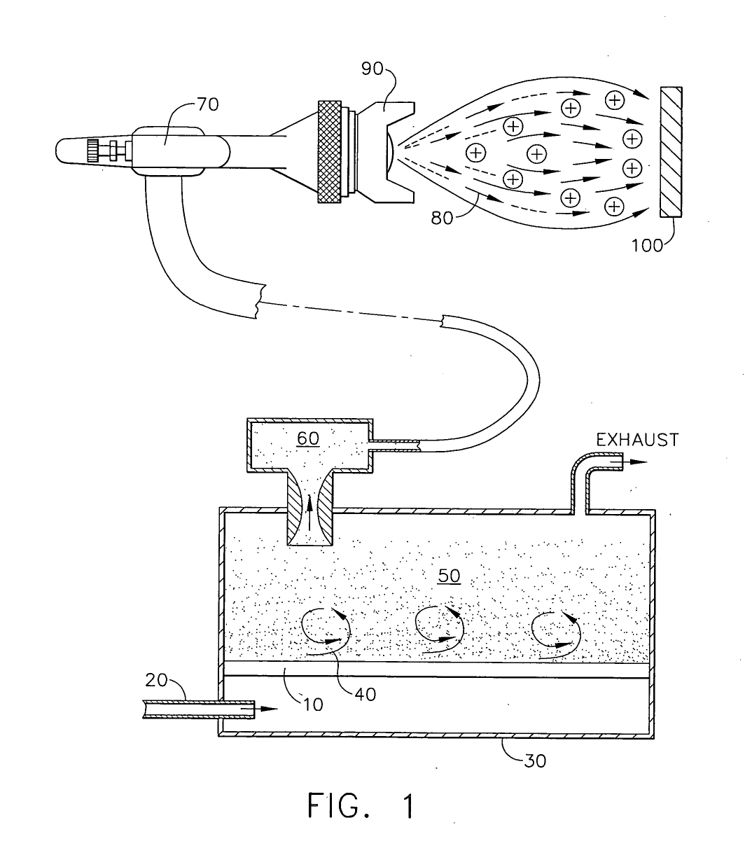

FIG. 1 schematically illustrates a tribo charging process for coating a gas turbine engine coating, in accordance with an embodiment of the invention. As shown in FIG. 1, an air supply 20 enters fluidizing chamber 30 including fluidizing air 40 and fluidizing powder 50. A porous medium 10, such as a porous polymeric material, may also often be placed between the incoming air and powder. The fluidizing powder 50 enters an atomizer 60 and exits as a mixture of powder and air where it then enters a tribo charging tube 70 or spray gun. Electrostatically charged particles 80 exit spray head 90 and are attracted to gas turbine engine component 100, which is grounded.

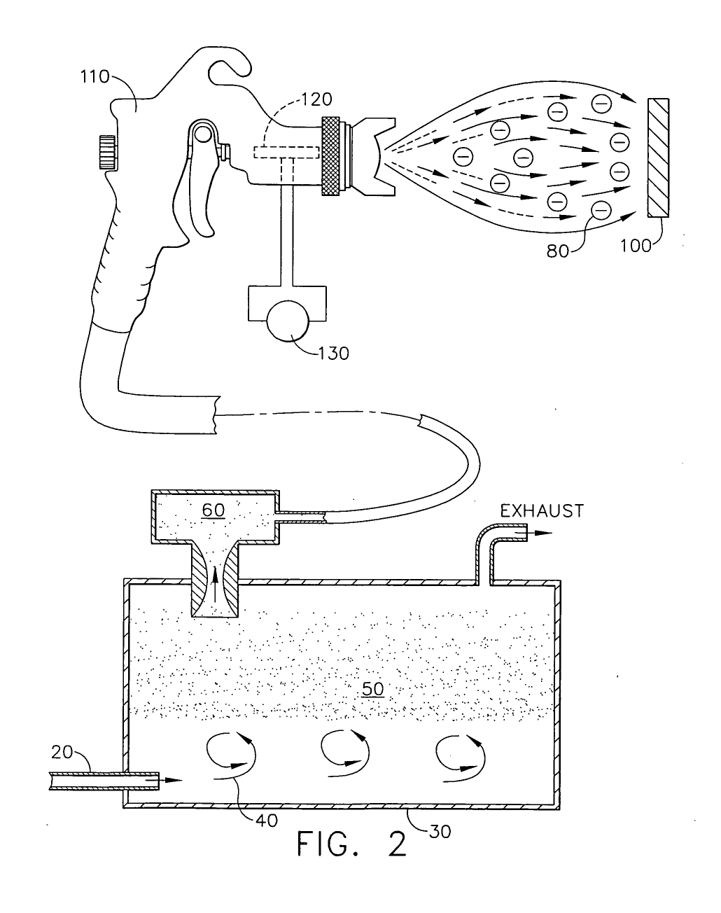

In the embodiment shown in FIG. 2, which shows a corona type electrostatic spray coating process, an air supply 20 enters fluidizing chamber 30 including fluidizing air 40 and fluidizing powder 50. The fluidizing powder 50 enters air atomizer 60 and exists as a mixture of powder and air where it then enters corona spray gun 110. Enclosed in gun 110 is an electrode 120 in contact with a high voltage 130 of a generator (not shown). Electrostatically charged particles 80 exit the spray gun 110 and are attracted to gas turbine engine component 100, which is also grounded as in the case of a tribo spraying processes.

The particle size distribution required for most commercial electrostatic spray apparatuses may typically be between about 10 and about 140 microns, with a mean particle size by volume within the range of about 15-75 microns. In the electrostatic spray process, powder coating particles are electrostatically charged and the charged particles are attracted to the substrate, which is earthed or oppositely charged. Any powder coating that does not adhere to the substrate can be recovered for re-use. Advantageously, the powder coatings are economical in use of ingredients, as well as non-polluting to the environment.

The powder may be cured on the substrate by application of heat, for instance by the process of stoving, typically for a period of from about 5 to about 30 minutes. Typically, the heating temperature is in the range of from about 150-400° C., although other suitable temperatures, such as about 120° C. may also be employed. These temperatures are particularly suitable for organic based powder coatings.

For high temperature glass/enamel and ceramic based coatings, firing may occur from about 200-2400° F. (93-1316° C.). Glass based or enamel powder compositions may also be used with metal or oxide additions to form high temperature thermal barrier coatings (TBC's). These may require temperatures between about 842-2800° F. (450-1538° C.) for between 5 minutes to 24 hours to achieve a proper cure. Cycle time is also dependent on the thickness of the coating. For example, a 50 mil coating may be heat treated to about 1540° F. (838° C.) in about 4 minutes. This is possible because no solvents or organics need to evolve.

The coating powder can be applied in a single sweep or in several passes. The thickness of the applied coating typically is less than or equal to about 200 microns, preferably less than about 50 microns, and most preferably less than about 30 microns for many applications. However, thicker TBC type ceramic/glass systems may be up to about 40+ mils (or 1016 microns) in thickness.

Preferably, a powder coating is applied to gas turbine engine component 100 by one of the afore-described electrostatic spray techniques. However, powder coatings may also be applied to gas turbine engine component 100 via conventional fluidized bed coating processes, which do not require the electrostatic charging of the powder prior to deposition. In a typical fluidized bed design, the bed is constructed as a booth or container including a top porous plate and a bottom air chamber. Powder is filled above the plate and is fluidized by the air below the plate. An electrically charged cloud of powder is formed, which is attracted to and deposits on the desired substrate exposed to the powder.

Embodiments of the invention will now be described by the following examples, which are meant to be merely illustrative and therefore nonlimiting.

### EXAMPLE 1

A ceramic enamel employed in this example was PG94C frit powder sold by Ferro Corporation. This powder is known as a groundcoat frit powder and comprises silica, barium, fluorides, nickel and zirconium compounds. The powder was used with a Norston powder coating system and the following parameters were employed: 50 psi atomization air, 50 psi flow air, 5 psi fluidization air to fluidized pot, and 90 KV charging. Powder was applied to both bond coated and non-bond coated Inconel 625 coupons. Thirty-nine passes yielded coatings up to 32 mils in thickness. The coatings were flash fired at 1540° F. (838° C.) for 4 to 6 minutes yielding a TBC coating. The bond coating employed was a conventional NiCrAlY coating, which was applied by plasma spray techniques.

### EXAMPLE 2

A ceramic enamel was leaded with an electrically isolated metal material to increase the thermal conduction of the coating. PG94C frit powder, 40% by weight, was mixed with alumina coated iron powder and then sprayed with use of a Norston powder coating system using the same parameters as in Example 1. A coating greater than 40 mils was developed and fired at 1540° F. (838° C.) in 6 minutes. Again, both bond coated and non-bond coated Inconel 625 were coated and both formed well adhered coating systems. Ferro's frit powder PL62D, which comprises silica, fluorides, nickel and zirconium compounds, may also be substituted for PG94C with thinner resultant coatings (e.g. 20-30 mils).

Advantages of the above examples include the following: rapid deposition, no drying time or solvents required, no adverse environmental, health and safety effects from solvents, rapid firing and great adhesion.

Additional advantages of embodiments of the invention include an absence of drying problems because the coating goes on dry, as well as an absence of polymer binder/aging problems. Moreover, Applicants' powder coating of gas turbine engine components is a fast process in which it is possible to coat and fire a component in less than 15 minutes. Similarly, the processes described herein are economical, result in high yields and are environmentally friendly in that no solvents are required. Advantageously, coatings such as thermal barrier coatings, sacrificial coatings, anticorrosion coatings and oxidation resistant coatings may be applied in accordance with embodiments of the invention.

While various embodiments are described herein, it will be appreciated from the specification that various combinations of elements, variations or improvements therein may be made by those skilled in the art, and are within the scope of the invention.

1-14. (canceled)

15. A gas turbine engine component comprising a powder coating thereon wherein the powder coating is selected from the group consisting of a sacrificial coating, a thermal barrier coating, an anticorrosion coating and an oxidation resistant coating.

16. A gas turbine engine component having a cured powder coating thereon, wherein the powder coating is applied in dry form without use of an organic solvent.
